(19) United States
(12) Patent Application Publication
(10) Pub. No.: US 2019/0167044 A1
(43) Pub. Date: Jun. 6, 2019

(54) CLEANING APPARATUS, SYSTEMS, DETERGENT COMPOSITIONS AND METHODS OF USING THE SAME

(71) Applicant: NatureSoft USA, LLC, Medinah, IL (US)

(72) Inventors: Domingo Mesa, Norridge, IL (US); Alexander Munoz, Medinah, IL (US)

(21) Appl. No.: 16/212,055

(22) Filed: Dec. 6, 2018

Related U.S. Application Data
(60) Provisional application No. 62/595,314, filed on Dec. 6, 2017.

(51) Int. Cl. A47K 3/28; B08B 3/02; B08B 3/04

(52) U.S. Cl. CPC A47K 3/281; B08B 3/04; B08B 3/026

(57) ABSTRACT

The present invention relates to cleaning apparatuses. Specifically, the present invention comprises an attachment for a standard shower head or other bathroom water line implement, wherein the attachment comprises a valve for routing water through a tube into a sprayer having an amount of shower or bathtub cleaner therein, wherein the water and cleaner mix to form a cleaning solution and are sprayed from the sprayer onto a shower or bathtub surface for cleaning the same. Preferred detergent compositions are further provided.

The present invention claims priority to U.S. Provisional Pat. App. No. 62/595,314, titled “Cleaning Apparatus, Systems, Detergent Compositions and Methods of Using the Same,” filed Dec. 6, 2017, which is incorporated herein by reference in its entirety.

### TECHNICAL FIELD

The present invention relates to cleaning apparatuses. Specifically, the present invention comprises an attachment for a standard shower head or other bathroom water line implement, wherein the attachment comprises a valve for routing water through a tube into a sprayer having an amount of shower or bathtub cleaner therein, wherein the water and cleaner mix to form a cleaning solution and are sprayed from the sprayer onto a shower or bathtub surface for cleaning the same. Preferred detergent compositions are further provided.

### BACKGROUND

Bathtubs and showers routinely require cleaning. Bathtubs and showers are utilized primarily for cleaning humans or animals, and as such dirt, viruses and/or bacteria may remain after use. Moreover, the moisture and heat generated by a bathtub or shower can lead to organic growth, such as mold and mildew. There are many products on the market for cleaning these areas, including powders, concentrates, mixes, sprays, or other like cleaners that can be deposited onto a surface within a bathtub or shower enclosure for cleaning the same.

Oftentimes, cleaners are difficult to work with when cleaning surfaces of a bathroom, such as within a bathtub or shower enclosure. If a powder, concentrate or mixture, they must often be mixed with water, typically within a bucket or other like container. Combining requisite ingredients together can be messy, time consuming, and may be done improperly, causing the cleaners to lose their effectiveness.

Moreover, cleaners in pressurized sprayers, such as spray cans and the like, are often limited based on their size, and typically when emptied, are thrown away as they are typically not refillable. This can lead to much waste, especially if cans or spray bottles have caustic cleaning residue therein, which can pose additional environmental challenges for waste disposal thereof.

Moreover, typical cleaners often are difficult to apply, and often fail to provide adequate coverage or foaming properties to maximize the contact of cleaning ingredients on surfaces. Specifically, cleaners that are powders, concentrates or mixes typically have little to no foaming properties. Moreover, cleaners that are sprayed from spray cans often only superficially cover surfaces without providing sufficient contact to surfaces. Oftentimes, chemical cleaners are either activated or provide enhanced cleaning power when used at elevated temperatures. However, typical foaming cleaners expelled from pressurized cans or the like are dangerous if heated and so cannot take advantage of enhanced cleaning due to added heat. Another drawback of typical spray cleaners is oftentimes the expulsion of foaming cleaning solution is difficult to control, and can results in splash back of the chemicals onto a user's body.

As noted above, water is often required to be mixed with powders, concentrates, mixes or the like for proper cleaning capabilities. When cleaning a bathtub or shower enclosure, it is often difficult to utilize the faucets to fill buckets or other like containers with water and mix with cleaning solution.

A need, therefore, exists for improved cleaning apparatuses for cleaning bathtub and shower enclosure surfaces. More specifically, a need exists for cleaning apparatuses that provide adequate cleaning capability to surfaces within bathtub and shower enclosures.

Moreover, a need exists for cleaning apparatuses that provide sufficient coverage of cleaning solutions to surfaces of bathtub and shower enclosures. In addition, a need exists for cleaning apparatuses that provide sufficient foaming of cleaning solutions to maximize cleaning of the surfaces of the bathtub and shower enclosures.

In addition, a need exists for cleaning apparatuses that may provide enhanced cleaning power due to use at elevated temperatures. Moreover, a need exists for cleaning apparatuses that offer easy control of foaming so that chemical splash-back is minimized or eliminated.

Further, a need exists for cleaning apparatuses that allow for proper mixing of water and cleaning solution, and further provide an easy and efficient foaming capability. Still further, a need exists for detergent compositions useful for improved cleaning apparatuses.

### SUMMARY OF THE INVENTION

The present invention relates to cleaning apparatuses. Specifically, the present invention comprises an attachment for a standard shower head or other bathroom water line implement, wherein the attachment comprises a valve for routing water through a tube into a sprayer having an amount of shower or bathtub cleaner therein, wherein the water and cleaner mix to form a cleaning solution and are sprayed from the sprayer onto a shower or bathtub surface for cleaning the same. Preferred detergent compositions are further provided.

To this end, in an embodiment of the present invention, a cleaning apparatus is provided. The cleaning apparatus comprises A cleaning apparatus comprising: a connector having a first valve thereon and configured to connect to a water dispensing pipe, wherein the connector routes water through a tube from the water dispensing pipe to a spray module having a spray nozzle and a trigger for opening the spray nozzle, configured to allow water to alternately flow directly through a cleaning apparatus outlet or to flow into a container configured to comprise detergent therein and configured to mix the water with the detergent to form a cleaning solution and then to flow through the cleaning apparatus outlet via a spray tube connecting the container to the cleaning apparatus outlet, wherein the cleaning apparatus outlet comprises a screen configured to agitate the cleaning solution to form suds as the cleaning solution flows therethrough.

In an embodiment, the connector is connected to a water dispensing pipe.

In an embodiment, the water dispensing pipe is a shower head inlet, and the connector is connected between the shower head inlet and the shower head.

In an embodiment, the cleaning apparatus further comprises: a chamber connected to the tube comprising a second valve, wherein the second valve alternately directs the water into the container or through the cleaning apparatus outlet.

In an embodiment, the container is separably connected to the chamber.

In an embodiment, the spray nozzle is separably connected to the chamber.

In an embodiment, the cleaning apparatus outlet is separably connected to the chamber.

In an embodiment, the container, the spray nozzle, and the cleaning apparatus outlet are separably connected to the chamber.

In an embodiment, the cleaning apparatus outlet comprises a plurality of screens that are stacked together.

In an embodiment, the container comprises an opening on a bottom thereof and a removable cap over the opening.

In an embodiment, the cleaning apparatus further comprises: detergent within the container configured to mix with the water to form the cleaning solution.

In an embodiment, the detergent is contained within a water soluble pouch within the container.

In an embodiment, the detergent produces carbon dioxide upon contact with water.

In an embodiment, the detergent comprises an amount of sodium bicarbonate.

In an embodiment, the detergent further comprises an acid.

In an embodiment, the acid is selected from the group consisting of citric acid, malic acid, succinic acid, adipic acid, and combinations thereof.

In an embodiment, the detergent further comprises a surfactant, such that upon contact of the detergent with water, carbon dioxide is released via the reaction of the acid and the sodium bicarbonate, forming the cleaning solution comprising a foam via interaction with the surfactant.

In an embodiment, the surfactant is an alkyl benzene sulfonic acid.

In an embodiment, the surfactant is dodecyl benzene sulfonic acid, Na Salt.

In an embodiment, the cleaning solution produces additional foam when the cleaning solution passes through the screen.

It is, therefore, an advantage and objective of the present invention to provide improved cleaning apparatuses for cleaning bathtub and shower enclosure surfaces.

More specifically, it is an advantage and objective of the present invention to provide cleaning apparatuses that provide adequate cleaning capability to surfaces within bathtub and shower enclosures.

Moreover, it is an advantage and objective of the present invention to provide cleaning apparatuses that provide sufficient coverage of cleaning solutions to surfaces of bathtub and shower enclosures.

In addition, it is an advantage and objective of the present invention to provide cleaning apparatuses that provide sufficient foaming of cleaning solutions to maximize cleaning of the surfaces of the bathtub and shower enclosures.

In addition, it is an advantage and objective of the present invention to provide cleaning apparatuses that may provide enhanced cleaning power due to use at elevated temperatures.

Moreover, it is an advantage and objective of the present invention to provide cleaning apparatuses that offer easy control of foaming so that chemical splash-back is minimized or eliminated.

Further, it is an advantage and objective of the present invention to provide cleaning apparatuses that allow for proper mixing of water and cleaning solution, and further provide an easy and efficient foaming capability.

Still further, it is an advantage and objective of the present invention to provide detergent compositions useful for improved cleaning apparatuses.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a cleaning apparatus in an embodiment of the present invention.

FIG. 2 illustrates an exploded view of a cleaning apparatus in an embodiment of the present invention.

FIG. 3 illustrates a cross-sectional view of a cleaning apparatus outlet in an embodiment of the present invention.

### DETAILED DESCRIPTION OF THE PRESENTLY PREFERRED EMBODIMENTS

The present invention relates to cleaning apparatuses. Specifically, the present invention comprises an attachment for a standard shower head or other bathroom water line implement, wherein the attachment comprises a valve for routing water through a tube into a sprayer having an amount of shower or bathtub cleaner therein, wherein the water and cleaner mix to form a cleaning solution and are sprayed from the sprayer onto a shower or bathtub surface for cleaning the same. Preferred detergent compositions are further provided.

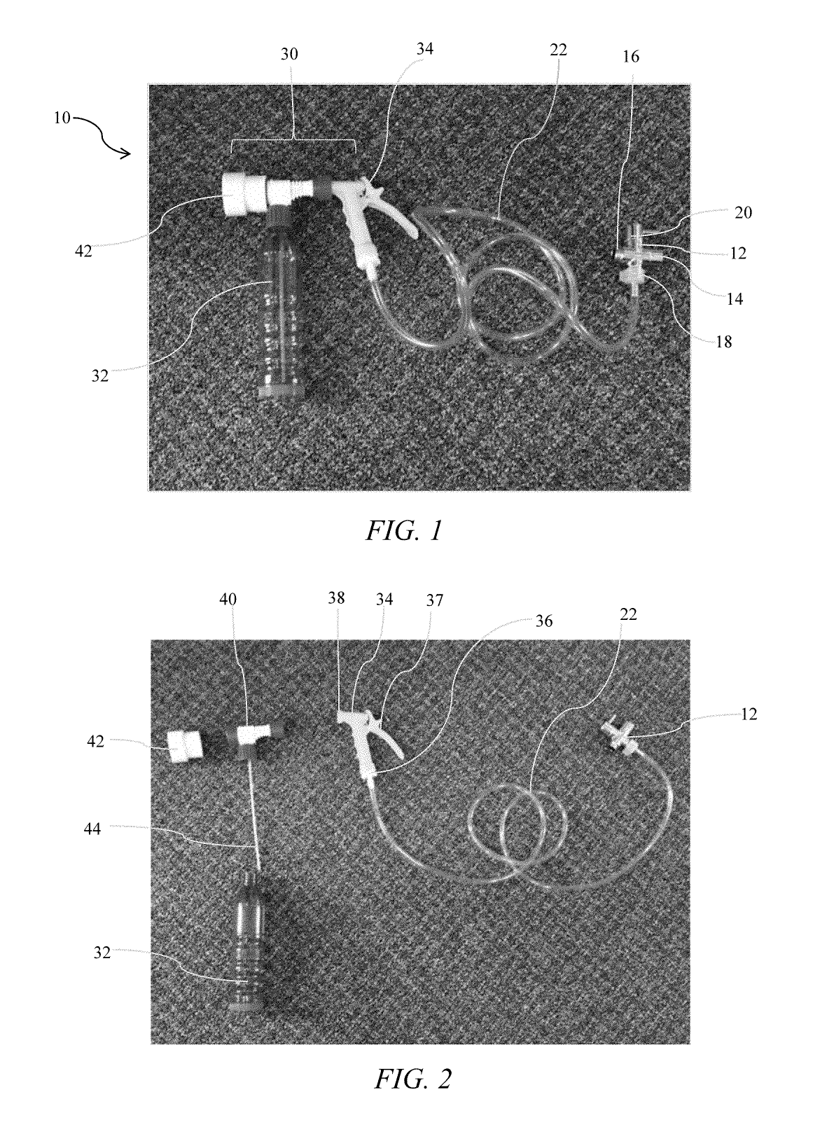

FIG. 1 illustrates a cleaning apparatus 10 in an embodiment of the present invention. The cleaning apparatus 10 may be utilized to clean a surface or an object, and the present invention should not be limited as described herein. In a preferred embodiment, the cleaning apparatus 10 may be utilized for cleaning the surfaces of a bathroom, such as the interior surfaces of a shower, bathtub, shower stall, hot tub, or other like surfaces within a bathroom.

The cleaning apparatus 10 may be connected to a water dispensing pipe via connector 12. The connector 12 may be connected to a shower dispensing pipe, for example, or any other pipe that allows water to be dispensed therefrom. The connector 12 comprises an inlet 14, an outlet 16, and a cleaning apparatus outlet 18. The connector 12 may further comprise a valve 20 for changing the flow of water through the connector, such as between flowing from the inlet 14 to the outlet 16 and flowing from the inlet 14 to the cleaning apparatus outlet 18. The connector 12 may be placed in-line with a shower head or other like water dispensing pipe, and may further be utilized with a hot and cold water valve for adjusting the temperature thereof.

Preferably, the connector 12 may be connected in-line with a shower head inlet, allowing a user to switch between dispensing the water through the shower head and dispensing the water through the cleaning apparatus 10. Thus, the cleaning apparatus 10 may be utilized within a shower or bathtub enclosure to clean the surfaces thereof easily and efficiently. The connector 12, in a preferred embodiment, may be connected permanently in-line with the shower head, and tubing 22 may extend from the connector 12. The tubing 22 may preferably be pressure fit onto a tube fitting (not shown) at the cleaning apparatus outlet 18, and therefore may be held onto the connector 12 when in use and removed therefrom when not in use. Therefore, a user may attach the tubing 22 to the pressure fitting on the cleaning apparatus outlet 18 of the connector 12 when use is desired.

The tubing 22 may preferably comprise a flexible tube that may route water from the connector 12 to a sprayer apparatus 30. The sprayer apparatus 30 may preferably route cleaning solution from a container 32 having an amount of detergent therein, where the detergent may have been previously combined with the water and form a cleaning solution. The cleaning solution may then be extracted from the container 32 as water flows through the sprayer apparatus 30 via the Venturi Effect and ejected from the sprayer apparatus 30 to cover a surface for cleaning the same.

As illustrated in FIG. 2, the sprayer apparatus 30 may comprise several components. Specifically, the sprayer apparatus 30 may comprise a spray module 34 that may accepts water from the tubing 22, such as through a spray module inlet 36 comprising a tube fitting (not shown) thereon. The spray module 34 may further comprise a trigger 37 acting as a valve that may alternately allow and prevent water from flowing through a nozzle 38. The water may thereby flow from the nozzle 38 through a chamber 40 to flow directly out a cleaning apparatus outlet 42. If the container 32 comprising the cleaning solution is open, the water flowing through the chamber 40 may pull the cleaning solution from the container 32 via the afore-mentioned Venturi Effect. Alternately, if the container 32 is closed and cleaning solution cannot flow into the chamber 40, water may flow directly therethrough to be used as a rinse.

Specifically, the chamber 40 may comprise 3 settings: 1) a “clean” setting that may route cleaning solution from the container 32 for mixing with water flowing therethrough; 2) a “rinse” setting that may close off the container 32 and route the water directly through the cleaning apparatus outlet 42; and 3) an “off” setting that blocks water from either entering the container 32 and bypassing the container 32. The setting may be in the form of a dial that allows a user to set the route of water through the chamber 40.

When the “clean” setting is selected, water from the spray module 34 may be routed through the chamber 40 and may pull cleaning solution from the container 32 due to passage from the container 32 of cleaning solution from the container 32 into the chamber 40 via a spray tube 44. As the cleaning solution is pulled up the spray tube 44 and mixes with the water, the cleaning solution and water mixture may be routed through the cleaning apparatus outlet 42. Thus, cleaning solution and water mixture may thus be applied to a surface or object for cleaning thereof. Likewise, when the “rinse” setting is selected, the container 32 may be closed and the water routed directly through the cleaning apparatus outlet 42 to be used for spraying pure water without cleaning solution therein to rinse a surface or an object. The water may flow through the various components when the trigger 37 is squeezed by a user, allowing pressurized water to flow therethrough, depending on the setting.

It should be noted that the water flowing through various components may experience pressure increases and drops as it flow therethrough, due to passage through relatively constricted and unrestricted passages. The overall effect may be a pressure drop of the water flowing therethrough that allows the cleaning solution and water mixture and/or the water by itself to be sprayed onto a surface or an object while minimizing splash-back. Minimizing splash-back may be particularly useful when spraying the cleaning solution and water mixture, as it minimizes contact between the cleaning solution and a user thereof.

As illustrated in FIG. 2, the container 32 may be separable from the chamber 40 through a screw cap. Likewise, the spray module 34 may be separable from the chamber 40 also through a screw cap. The cleaning apparatus outlet 42 may further be separably connected to the chamber 40, such as via threads, but may also be pressure fit to the chamber. The cleaning apparatus outlet 42 may allow the both the cleaning solution and the rinse water to eject therefrom, forming a spray of either to maximize coverage.

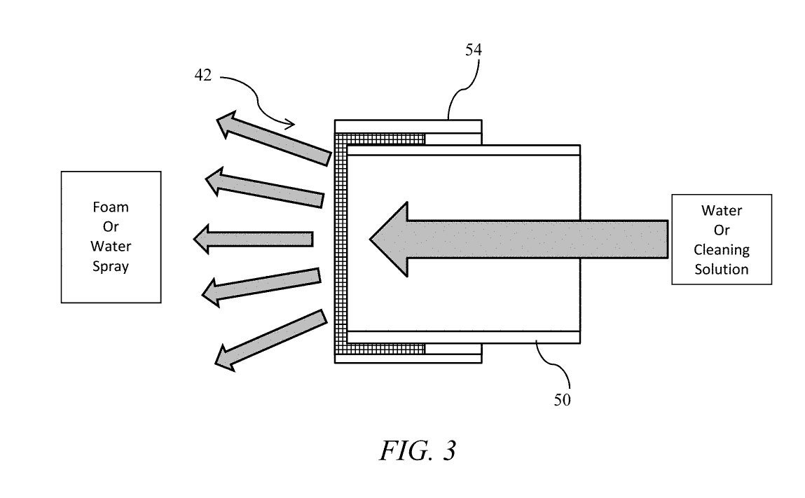

In a preferred embodiment, illustrated in FIG. 3, a cross-sectional view of the cleaning apparatus outlet 42 is illustrated. A cleaning solution and water mixture or rinse water may flow through a main housing 50. The main housing 50 may have a screen 52 on an end thereof that the water and cleaning solution must pass through. The screen 52 may preferably be held to the end thereof via a cap 54 that may be held onto the end thereof in any manner apparent to one of ordinary skill in the art, such as via threads, pressure fit, adhesive, or in any other like manner. The screen 52 may agitate and break up the water stream and the cleaning solution stream and form a spray. More preferably, the screen 52 may break up and agitate the cleaning solution stream, enhancing the formation of cleaning suds or foam that may be utilized on a surface or an object to maximize cleaning thereof. In a preferred embodiment, the screen 52 may preferably be formed from several screens that are placed adjacent one another, thereby providing a tortuous path for the cleaning solution to flow through, thereby even further enhancing the agitation and the creation of suds and foam. The screen 52 may also contribute to minimizing splash-back of the cleaning solution and water mixture by interfering with and therefore decreasing the flow rate of the mixture therethrough.

All of the various components may be modular and separable from each other, as shown in FIG. 2, to allow the parts to be easily taken apart for cleaning and/or storage thereof. As noted above, the various parts may be connected to each other through separable connections, such as through pressure fittings and/or through threaded connections as apparent to one of ordinary skill in the art. Thus, a single cleaning apparatus 10 may be utilized to clean several bathtub or shower enclosures, such as may be found within a hotel, motel dormitory or other like facility having multiple shower or bathtub enclosures. Of course, the present invention may also be useful within a home having a plurality of bathrooms therein for the same purpose. Thus, the cleaning apparatus 10 may be brought to each bathroom for cleaning the same, whereby the tubing 22 is hooked up to a connector 12 that may be permanently disposed in each bathroom, pressure fit to the cleaning apparatus outlet 18 thereof, and utilized as disclosed above for cleaning the surfaces thereof.

The detergent that may be utilized within the container 32 and mixed with the water may be any detergent useful for serving such a purpose, and may further easily dissolve in water and create suds for cleaning and/or sterilizing surfaces or objects. In a preferred embodiment, the detergent may be contained within a water soluble pouch that may dissolve when introduced to water. Within the soluble pouch may be a dry or liquid detergent concentrate that, when dissolved within the water introduced to the container 32, forms an effective cleaning solution for use with the present invention.

Specifically, the container 32 may preferably have two openings, a first opening for disposing on the spray apparatus 30, wherein the spray tube 44 may pull cleaning solution into the chamber 40, and a second opening (shown at the bottom of the container 32) whereby both the detergent and sufficient water to dissolve the same to form the cleaning solution may be introduced. Preferably, the detergent, within a water soluble pouch, may be disposed within the container 32 through the second opening followed by an amount of water. Alternatively, water may first be disposed within the container 32 through the second opening followed by introduction thereto of the detergent within the water soluble pouch. The container 32 may be closed and the detergent may be dissolved within the water.

Although any detergent composition may be utilized, as apparent to one of ordinary skill in the art, a preferred detergent composition easily produces bubbles and foam to aid in cleaning a surface or an object, causing the cleaning solution to better cling to the surface or object. As noted above, the screen 52 may mechanical stress the cleaning solution, agitating the cleaning solution to produce foam. Likewise, a detergent composition that produces foam upon contact with water is preferred. For example, a CO2-producing detergent composition may create foam when in contact with water. When the CO2-producing detergent composition is further agitated through the screen 52, foaming of the cleaning solution may be enhanced. In the event of using a CO2-producing detergent that may be activated with heated water, the detergent may be dissolved in cold water within the container 32 to minimize pressure build-up and to prevent or delay the release of CO2. Then, when the cold cleaning solution within the container 32 is pulled into the chamber 40, the water flowing therethrough may be heated water, causing the cold cleaning solution to mix with the heated water and activating it, producing enhanced cleaning abilities, such as formation of CO2 and foam thereby.

The following provides various detergent compositions that may be useful for cleaning surfaces and/or objects according to the present invention:

Formula #1 (alkaline)

| Component | Concentration |
|---|---|
| DDBSA, Na salt (Thonyl) | 64.00% |
| Sodium carbonate, dense | 20.00% |
| Sodium bicarbonate | 16.00% |
| granular | |
| Blue dye | 0.01% |
| Fragrance (lime | 0.25% |
| FN337560) | |

Formula #2 (acidic with pressure building)

| Component | Concentration |
|---|---|
| DDBSA, Na salt (Thonyl) | 64.00% |
| Citric Acid | 20.00% |
| Sodium bicarbonate | 16.00% |
| granular | |
| Blue dye | 0.01% |
| Fragrance (lime FN337560) | 0.25% |

CO2 may be produced according to Formula #2 due to the presence of sodium bicarbonate and an acid, such as citric acid, in contact with water. Other acids may further be useful, such as malic acid, succinic acid, adipic acid, or any other acid apparent to one of ordinary skill in the art to react with the sodium bicarbonate in the presence of water to form a carbonated cleaning solution. Specifically, CO2 may be produced when Formula #2 is dissolved in water, such as when water is added to the container 32 and dissolves a water soluble pouch containing Formula #2. For example, a 56 g water soluble pouch of Formula #2 dissolved in 1 L of water produces around 4.4 g of CO2, thereby producing a carbonated cleaning solution. When in contact with hot water, CO2 solubility may decrease, forcing the CO2 gas to leave the liquid phase. When CO2 leaves the liquid phase, foam may be produced when the CO2 forms bubbles with the surfactant, such as an alkyl benzene sulfonic acid, namely dodecyl benzene sulfonic acid, Na salt (commonly known as Thonyl or DDBSA), as shown in Formulas #1 and #2. Moreover, as noted above, the mechanical stress of the cleaning solution hitting the foam screen and agitated thereby favors bubble release from the liquid which, in conjunction with the surfactant, may produce high foam.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A cleaning apparatus comprising:
a connector having a first valve thereon and configured to connect to a water dispensing pipe, wherein the connector routes water through a tube from the water dispensing pipe to a spray module having a spray nozzle and a trigger for opening the spray nozzle, configured to allow water to alternately flow directly through a cleaning apparatus outlet or to flow into a container configured to comprise detergent therein and configured to mix the water with the detergent to form a cleaning solution and then to flow through the cleaning apparatus outlet via a spray tube connecting the container to the cleaning apparatus outlet,
wherein the cleaning apparatus outlet comprises a screen configured to agitate the cleaning solution to form suds as the cleaning solution flows therethrough.

2. The cleaning apparatus of claim 1 wherein the connector is connected to a water dispensing pipe.

3. The cleaning apparatus of claim 2 wherein the water dispensing pipe is a shower head inlet, and the connector is connected between the shower head inlet and the shower head.

4. The cleaning apparatus of claim 1 further comprising:
a chamber connected to the tube comprising a second valve, wherein the second valve alternately directs the water into the container or through the cleaning apparatus outlet.

5. The cleaning apparatus of claim 4 wherein the container is separably connected to the chamber.

6. The cleaning apparatus of claim 4 wherein the spray nozzle is separably connect to the chamber.

7. The cleaning apparatus of claim 4 wherein the cleaning apparatus outlet is separably connected to the chamber.

8. The cleaning apparatus of claim 4 wherein the container, the spray nozzle, and the cleaning apparatus outlet are separably connected to the chamber.

9. The cleaning apparatus of claim 1 wherein the cleaning apparatus outlet comprises a plurality of screens that are stacked together.

10. The cleaning apparatus of claim 1 wherein the container comprises an opening on a bottom thereof and a removable cap over the opening.

11. The cleaning apparatus of claim 1 further comprising:
detergent within the container configured to mix with the water to form the cleaning solution.

12. The cleaning apparatus of claim 11 wherein the detergent is contained within a water soluble pouch within the container.

13. The cleaning apparatus of claim 11 wherein the detergent produces carbon dioxide upon contact with water.

14. The cleaning apparatus of claim 11 wherein the detergent comprises an amount of sodium bicarbonate.

15. The cleaning apparatus of claim 14 wherein the detergent further comprises an acid.

16. The cleaning apparatus of claim 15 wherein the acid is selected from the group consisting of citric acid, malic acid, succinic acid, adipic acid, and combinations thereof.

17. The cleaning apparatus of claim 15 wherein the detergent further comprises a surfactant, such that upon contact of the detergent with water, carbon dioxide is released via the reaction of the acid and the sodium bicarbonate, forming the cleaning solution comprising a foam via interaction with the surfactant.

18. The cleaning apparatus of claim 17 wherein the surfactant is an alkyl benzene sulfonic acid.

19. The cleaning apparatus of claim 18 wherein the surfactant is dodecyl benzene sulfonic acid, Na Salt.

20. The cleaning apparatus of claim 17 wherein the cleaning solution produces additional foam when the cleaning solution passes through the screen.
